(19) United States
(12) Patent Application Publication
(10) Pub. No.: US 2024/0362634 A1
(43) Pub. Date: Oct. 31, 2024

(54) SYSTEM AND METHOD TO ORCHESTRATE RESOURCE INSTRUMENTS IN AN ELECTRONIC NETWORK UTILIZING UNIQUE HASH TOKENS

(71) Applicant: BANK OF AMERICA CORPORATION, Charlotte, NC (US)

(72) Inventor: Nisha Dahiya, Adarsh Nagar (IN)

(73) Assignee: BANK OF AMERICA CORPORATION, Charlotte, NC (US)

(21) Appl. No.: 18/140,854

(22) Filed: Apr. 28, 2023

(51) Int. Cl. G06Q 20/40; G06Q 20/38

(52) U.S. Cl. CPC G06Q 20/40145; G06Q 20/389

(57) ABSTRACT

Systems, computer program products, and methods are described herein orchestrating resource instruments in an electronic network utilizing unique hash tokens. The invention relates to a system and method for managing and processing transactions using non-fungible tokens (NFTs) representing NFT checks. The system receives resource action data from an end-point device of a user and determines metadata from the resource action data required for generating the NFT check. The system performs a voice verification of the user via data received from the end-point device to authenticate the user's identity. Utilizing a distributed ledger architecture, the system generates the NFT based on the metadata and transmits unique hash code data representing the NFT to an entity resource account management and settlement repository. The system further generates a link to the NFT and transmits the link to the end-point device of the user, enabling secure, efficient, and user-friendly financial transactions leveraging NFT technology.

### TECHNOLOGICAL FIELD

The present invention relates generally to the field of resource actions, and more specifically, to a method and system for managing and securing resource instruments using non-fungible tokens (NFTs).

### BACKGROUND

Resource instruments are commonly used for payments and transfers of funds between bank accounts. However, the traditional paper-based resource instrument system has several drawbacks, including the potential for lost or misappropriated instruments, malfeasance, and delayed processing times due to guideline updates or other issues. Additionally, the reliance on paper resource instruments can lead to increased costs for entities related to issuing and replacing instruments.

Applicant has identified a number of deficiencies and problems associated with orchestrating resource instruments in an electronic network utilizing unique hash tokens. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for orchestrating resource instruments in an electronic network utilizing unique hash tokens.

The present invention is directed to a method and system for providing a smart and secure resource instrument management system using non-fungible tokens (NFTs). The system may include components such as a metadata engine, an NFT manager, and a negotiation and encashment module.

In one aspect, the metadata engine may be responsible for extracting the metadata required for generating an NFT resource instrument. This metadata may include verification information based on voice recognition and phrase matching, as well as a unique resource instrument pass code provided by the customer or resource instrument NFT owner.

In another aspect, the NFT manager may create the NFT resource instrument using the metadata provided by the metadata engine. The NFT resource instrument may be generated using the verification information, instrument details, and resource instrument pass code. Additionally, each time the NFT resource instrument is endorsed or transferred to another person, a new resource instrument pass code must be provided, which will become part of the NFT's metadata.

In yet another aspect, the negotiation and encashment module may be responsible for facilitating the realization of the NFT resource instrument amount through transfers or cash withdrawals by the NFT resource instrument owner.

By employing the method and system disclosed herein, resource instrument malfeasance and forgery can be significantly reduced, as NFT resource instruments are instantly generated and securely stored in a distributed ledger. Furthermore, this invention may reduce costs for banks associated with issuing and replacing resource instruments.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for orchestrating resource instruments in an electronic network utilizing unique hash tokens, in accordance with an embodiment of the disclosure;

FIGS. 2A-2B illustrate an exemplary distributed ledger technology (DLT) architecture, in accordance with an embodiment of the invention;

FIG. 3A-3B illustrates an exemplary process of creating an NFT 300, in accordance with an embodiment of the invention;

FIG. 4 illustrates a process flow for NFT check transfer and endorsement, in accordance with an embodiment of the disclosure; and

FIG. 5 illustrates an exemplary process flow NFT check request, generation, and processing, in accordance with an embodiment of an invention.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, an “entity” refers to an organization that engages in activities related to the management, investment, and facilitation of financial transactions or resource transactions. These activities may include, but are not limited to, the provision of banking services, credit extensions, securities brokerage, resource management, and insurance services. Entities may encompass a variety of entities such as banks, credit unions, investment firms, insurance companies, and other similar organizations. In certain implementations, an entity may operate through physical branches, online platforms, or a combination of both, to offer services to individuals, businesses, and other entities. For the purpose of this disclosure, an entity is typically involved in the creation, management, and execution of financial transactions and may collaborate with other institutions, regulatory bodies, and technology providers to ensure the security, efficiency, and compliance of its operations.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, a “resource account” refers to an account that holds resources which can be transferred or distributed through transactions or activities between one or more entities, including the user. The term “resource transfer,” “resource distribution,” or “resource allocation” may refer to any transaction, activities or communication involving the user's resource or account. This can include a payment, processing of funds, purchase of goods or services, return of goods or services, a payment transaction, a credit transaction, or any other interactions involving the user's resources or account. The account can be associated with a financial institution or other entity and can be used to conduct various financial transactions such as point of sale transactions, online shopping, person-to-person transfers, and electronic funds transfers. Additionally, the account may be used to perform non-financial activities such as changing a password, adding new accounts, modifying account parameters, and performing authentication procedures.

As used herein, “payment instrument” may refer to an electronic payment vehicle, such as an electronic credit or debit card, as well as physical or digital checks. The payment instrument may not be a “card” at all and may instead be account identifying information stored electronically in a user device, such as payment credentials or tokens/aliases associated with a digital wallet, or account identifiers stored by a mobile application. Physical or digital checks can also serve as payment instruments, providing a method for transferring funds from one party to another through written, paper-based, or electronic means. These payment instruments facilitate transactions by enabling the exchange of funds between parties, backed by the security and verification processes associated with each type of payment method.

As used herein, an “ACH payment” may generally refer to a financial transaction processed through the Automated Clearing House (ACH) network. The ACH network is a nationwide electronic funds transfer (EFT) system that facilitates the movement of funds between banks and financial institutions in the United States. In some example implementations, ACH payments may include direct deposit transactions, bill payments, payroll deposits, tax refunds, or other types of electronic transfers. ACH payments are typically characterized by their cost-effectiveness, efficiency, and reliability compared to traditional paper-based payment methods, such as checks. For purposes of this disclosure, an ACH payment is processed and settled through a secure and regulated system that connects financial institutions, enabling the exchange of funds and transaction details between parties in a standardized and efficient manner.

As used herein, a “Non-Fungible Token” (NFT) may generally refer to a unique, indivisible, and digitally verifiable unit of ownership representing a digital or physical item. NFTs are based on blockchain technology, providing a transparent and decentralized ledger for the provenance and ownership of the item in question. In some example implementations, NFTs may be associated with digital art, collectibles, music, video entertainment, or other forms of creative content. Additionally, NFTs can represent physical items or real-world possessions, such as real estate, physical artworks, or other tangible goods. For purposes of this disclosure, an NFT is typically stored on a blockchain network-a distributed digital ledger where unique tokens are minted, transferred, and tracked, ensuring the security and authenticity of the item associated with the NFT.

As used herein, a “distributed ledger” may generally refer to a consensus-driven, decentralized database that records and synchronizes transactions across multiple nodes, or participants, in a network. This technology provides a transparent, secure, and tamper-resistant method for maintaining and verifying transaction records without the need for a central authority. In some example implementations, distributed ledgers may be associated with blockchain technology, which employs cryptographic techniques to ensure the integrity, authenticity, and immutability of transaction records. Distributed ledgers can be used for various applications, including but not limited to, financial transactions, supply chain management, polling systems, and identity verification. For purposes of this disclosure, a distributed ledger is typically maintained by a network of nodes that cooperatively validate, store, and update transactions, ensuring data consistency and security across the entire network.

As used herein, a “hash token” or “unique hash token” may generally refer to a fixed-length, alphanumeric string generated by applying a cryptographic hash function to a specific input, such as a file, a message, or transaction data. The unique hash token represents a digital fingerprint of the input and has the property that even a small change in the input will produce a significantly different hash output. In some example implementations, hash tokens may be used for various purposes, including data integrity verification, digital signatures, proof of work, and as identifiers for objects or transactions in distributed ledger systems like blockchains. For purposes of this disclosure, a hash token is typically created using a deterministic algorithm, ensuring that the same input will always generate the same hash output, allowing for efficient and secure data validation, indexing, and comparison in various applications.

As used herein, deterministic algorithms may generally refer to a class of algorithms that produce consistent and predictable outputs for a given set of inputs. These algorithms follow a predefined set of rules or steps, ensuring that the same input will always generate the same output. Examples of deterministic algorithms include Merge Sort, which is a comparison-based sorting algorithm that divides an array into halves, sorts each half, and then merges the sorted halves back into a single sorted array; Binary Search, an efficient search algorithm that operates on a sorted array or list by repeatedly dividing the search interval in half; Dijkstra's Shortest Path Algorithm, a graph traversal algorithm used to find the shortest path between nodes in a weighted graph with non-negative edge weights; and the Euclidean Algorithm, a method for finding the greatest common divisor (GCD) of two integers. For purposes of this disclosure, deterministic algorithms play a crucial role in various applications and systems, offering reliability, predictability, and consistency in their execution, enabling the development of efficient and dependable software solutions.

As used herein, a “metadata engine” may generally refer to a software component or system responsible for extracting, processing, and managing metadata associated with the generation and management of check-based Non-Fungible Tokens (NFTs). In some example implementations, the metadata engine may interact with a calling engine that verifies a customer's identity through voice recognition and phrase matching techniques, producing a verification percentage. This verification percentage, combined with a unique check passcode, is utilized during the NFT check creation process. The check passcode is intended for one-time use, and the customer or check NFT owner is required to provide a new check passcode whenever the check ownership is transferred or negotiated to another party. For purposes of this disclosure, a metadata engine is a critical component that ensures the secure and efficient creation, transfer, and management of check-based NFTs by processing and handling metadata, customer authentication, and passcode management.

In some example implementations, a combination of passcodes and voice matching may be used to verify a person's identity through a percentage match verification technique. This process involves collecting a voice sample of the user during registration, which is securely stored and associated with the user's account as a reference for future identity verification. A unique passcode is generated or provided by the user, serving as an additional layer of security. When the user needs to authenticate their identity, the system prompts them to provide their passcode and a new voice sample. The system compares the provided passcode with the stored passcode, and if they match, proceeds to the voice matching step. Voice recognition algorithms analyze the characteristics of the user's voice, such as pitch, tone, and speaking patterns, to determine the similarity between the samples. Based on the comparison results, a percentage match score is calculated, and the system compares this score with a predefined threshold value. If the percentage match score meets or exceeds the threshold value, the user's identity is considered verified, and the system grants access or approves the requested action. This percentage match verification technique using passcodes and voice matching offers a secure and efficient method for authenticating a person's identity, leveraging multiple factors to increase the reliability and security of the authentication process.

In the realm of biometric voice matching, various algorithms are employed to analyze and compare voice samples to determine their similarity. One such example is the Mel Frequency Cepstral Coefficients (MFCC) algorithm, which extracts the most relevant features of a voice sample by mimicking the human auditory system's perception of sound. Another example is the Gaussian Mixture Model (GMM), which represents the extracted features as a combination of Gaussian distributions, effectively modeling the statistical properties of the voice features. Additionally, Dynamic Time Warping (DTW) is an algorithm that can be used to measure the similarity between two temporal sequences by aligning them in a time-normalized manner.

Programmatically and mathematically, the voice matching process typically involves several steps. First, preprocessing is performed on the voice samples to reduce noise, normalize volume, and remove silence. Next, feature extraction is carried out to obtain a compact representation of the voice samples, which is achieved by applying algorithms such as MFCC. After feature extraction, the resulting feature vectors are compared and analyzed using techniques like GMM or DTW to measure the similarity between the voice samples.

In the case of percentage calculations, a similarity score is obtained by comparing the aligned feature vectors using distance metrics, such as Euclidean distance or Mahalanobis distance. This score is then normalized to a scale ranging from 0 to 100, where 0 represents no similarity and 100 represents a perfect match. The normalization process can involve dividing the obtained similarity score by the maximum possible score and multiplying the result by 100 to obtain the percentage match. Biometric voice matching and percentage calculations involve a series of steps, including preprocessing, feature extraction, comparison of feature vectors, and normalization of similarity scores. By employing algorithms such as MFCC, GMM, and DTW, voice matching systems can effectively determine the similarity between voice samples and express this as a percentage match, providing a reliable and quantifiable measure of voice-based identity verification.

As used herein, an “NFT manager” may generally refer to a software component or system responsible for creating, transferring, and managing Non-Fungible Tokens (NFTs) associated with checks, utilizing metadata provided by a metadata engine. In some example implementations, the NFT manager generates an NFT for a check when it is created for the first time, incorporating the verification percentage, check details, and check passcode obtained from the metadata engine. When the check is endorsed or transferred to another person, the NFT manager requires the provision of a new check passcode, which becomes part of the metadata for the updated NFT. For purposes of this disclosure, an NFT manager is a critical component that enables the secure and efficient management of check-based NFTs by handling the creation, endorsement, and transfer of NFTs, while ensuring that the necessary metadata, including passcodes, is properly incorporated and updated throughout the lifecycle of the NFT.

As used herein, a “negotiation and encashment component” may generally refer to a software component or system responsible for facilitating the realization of check amounts associated with Non-Fungible Token (NFT) checks through funds transfer or cash withdrawal by the NFT check owner. In some example implementations, the negotiation and encashment component handles the process of verifying, endorsing, and cashing NFT checks, ensuring that the check owner can seamlessly access and utilize the check's value. For purposes of this disclosure, a negotiation and encashment component is a critical element in the management of check-based NFTs, providing the necessary functionality to enable secure and efficient transactions, transfers, and withdrawals associated with NFT check ownership and use.

In technical terms, the problem statement can be described as follows: Traditional checks are commonly utilized as a method of payment or funds transfer, with banks issuing checkbooks to customers upon account opening, checkbook loss, or when all checks in a checkbook have been used. However, there are several challenges associated with the use of physical checks. When a checkbook is lost, customers must request a new one, which may result in delays. Additionally, government regulations may mandate changes to check details, necessitating the issuance of new checkbooks.

Remote locations without internet access or debit card availability may pose difficulties for customers or their relatives in urgent need of funds. Electronic checks (e-checks) attempt to address this issue by allowing users to scan and remotely deposit checks as images. However, this approach is susceptible to malfeasance, as advanced tools can be used to manipulate check images. Furthermore, when a check image is shared with another individual who then deposits the check, malfeasant activities may occur, including check forgery.

To address these challenges, a secure, efficient, and reliable system is required to authenticate, manage, and process check transactions while minimizing the potential for malfeasance. This can be achieved through the use of advanced cryptographic techniques, biometric authentication, and distributed ledger technology. By combining these technologies, the system can ensure the integrity of check transactions, maintain a transparent and tamper-resistant record of ownership and transfer, and provide robust identity verification for check issuers and recipients, ultimately reducing the likelihood of check malfeasance and enhancing the security of check-based transactions.

The proposed solution aims to implement an advanced, secure check management system, utilizing Non-Fungible Tokens (NFTs) for check generation, negotiation, and transfer, while minimizing the possibility of malfeasant behavior. This system comprises three main components. The Metadata Engine is responsible for extracting the necessary metadata required for generating the NFT check. It initiates a call to the customer, and a verification percentage is calculated based on voice recognition and phrase matching. The verification percentage, along with a unique check passcode, and in some embodiments may only be required once during NFT check creation. The customer or NFT check owner must provide a new check passcode every time the check is negotiated to another person, signifying a change in ownership.

The NFT Manager creates the NFT using the metadata provided by the Metadata Engine. When the check is created for the first time, the verification percentage, check details, and check passcode are used. When the check is endorsed to another person, a new check passcode must be provided, which becomes part of the metadata for NFT creation. The Negotiation and Encashment component is responsible for realizing the NFT check amount through funds transfer or cash withdrawal by the NFT check owner. This component ensures that the check's value is seamlessly accessible and utilized by the owner while maintaining the security and integrity of the check transaction. By integrating these three components, the system offers a smart and secure method for managing checks as NFTs, ensuring secure and efficient transactions while significantly reducing the possibility of malfeasant behavior.

Systems, computer program products, and methods are described herein orchestrating resource instruments in an electronic network utilizing unique hash tokens. The invention relates to a system and method for managing and processing transactions using non-fungible tokens (NFTs) representing NFT checks. The system receives resource action data from an end-point device of a user and determines metadata from the resource action data required for generating the NFT check. The system performs a voice verification of the user via data received from the end-point device to authenticate the user's identity. Utilizing a distributed ledger architecture, the system generates the NFT based on the metadata and transmits unique hash code data representing the NFT to an entity resource account management and settlement repository. The system further generates a link to the NFT and transmits the link to the end-point device of the user, enabling secure, efficient, and user-friendly financial transactions leveraging NFT technology.

What is more, the present disclosure provides a technical solution to a technical problem. As described herein, the technical problem includes the possibility of malfeasant behavior in traditional check management systems and the inefficiencies associated with physical checks. The technical solution presented herein allows for secure, efficient check management through the utilization of Non-Fungible Tokens (NFTs) for check generation, negotiation, and transfer. In particular, the NFT-based check management system is an improvement over existing solutions to the problem of malfeasant behavior and inefficiencies, (i) with fewer steps to achieve the solution, thus reducing the amount of computing resources, such as processing resources, storage resources, network resources, and/or the like, that are being used, (ii) providing a more accurate solution to the problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

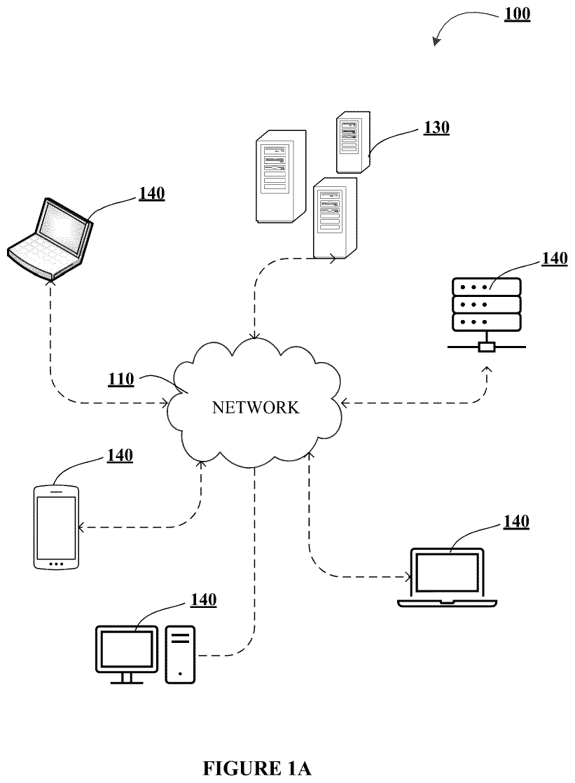

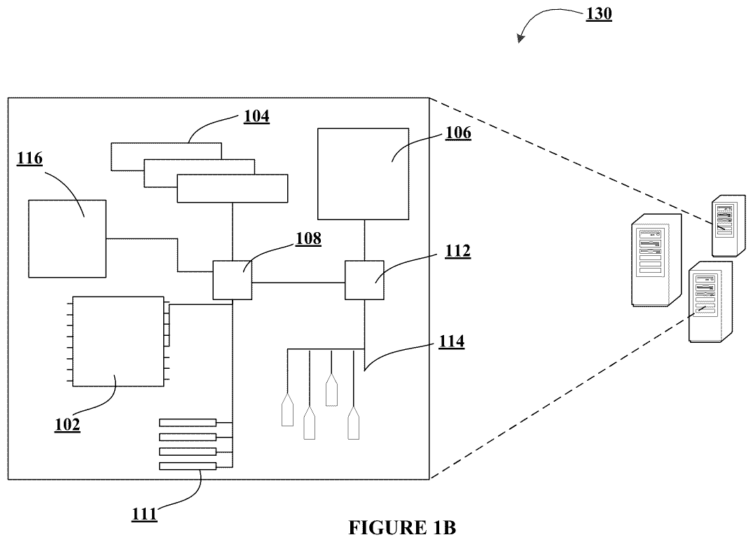

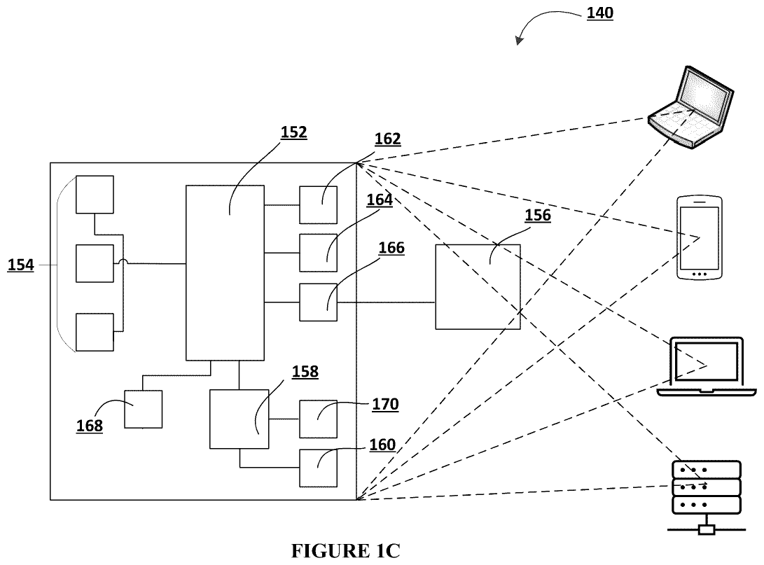

FIGS. 1A-1C illustrate technical components of an exemplary distributed computing environment 100 for orchestrating resource instruments in an electronic network utilizing unique hash tokens, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned. In some embodiments, the system 130 is managed by an entity responsible for the system of the invention.

As such, the system 130 may generally include the various critical components of the invention, such as the metadata engine responsible for extracting, processing, and managing metadata associated with the generation and management of check-based Non-Fungible Tokens (NFTs). The system 130 may also include the NFT manager 402, a software component or system responsible for creating, transferring, and managing Non-Fungible Tokens (NFTs) associated with checks, utilizing metadata provided by a metadata engine. In some example implementations, the NFT manager generates an NFT for a check when it is created for the first time, incorporating the verification percentage, check details, and check passcode obtained from the metadata engine. When the check is endorsed or transferred to another person, the NFT manager requires the provision of a new check passcode, which becomes part of the metadata for the updated NFT. For purposes of this disclosure, an NFT manager is a critical component that enables the secure and efficient management of check-based NFTs by handling the creation, endorsement, and transfer of NFTs, while ensuring that the necessary metadata, including passcodes, is properly incorporated and updated throughout the lifecycle of the NFT. The system 130 may also include the negotiation and encashment component, a software component or system responsible for facilitating the realization of check amounts associated with Non-Fungible Token (NFT) checks through funds transfer or cash withdrawal by the NFT check owner. In some example implementations, the negotiation and encashment component is responsible for the process of verifying, endorsing, and cashing NFT checks, ensuring that the check owner can seamlessly access and utilize the check's value. For purposes of this disclosure, a negotiation and encashment component is a critical element in the management of check-based NFTs, providing the necessary functionality to enable secure and efficient transactions, transfers, and withdrawals associated with NFT check ownership and use.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like. The end-point device(s) 140 enable one or more user(s) to communicate with the system 130 and utilize the invention described herein.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

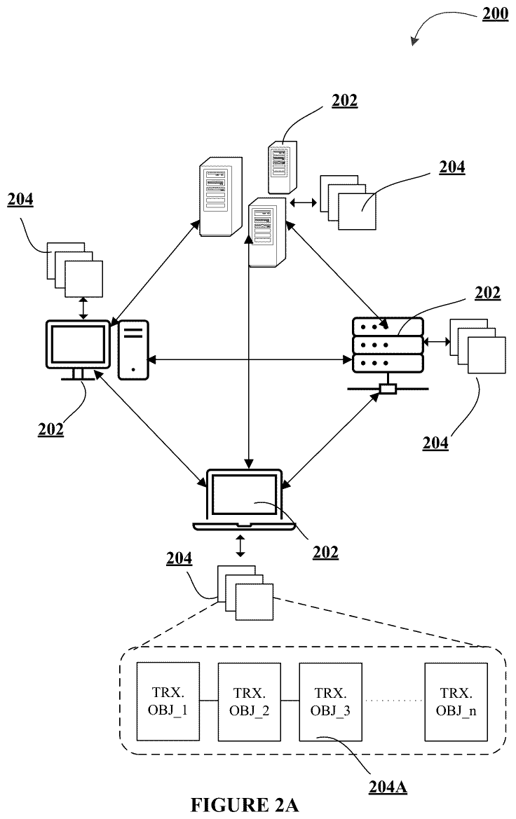

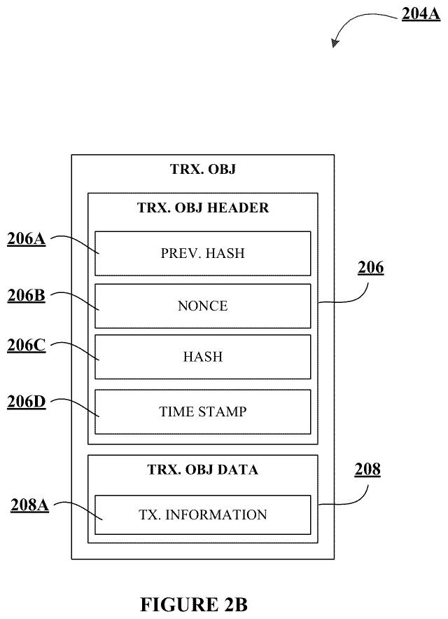

FIGS. 2A-2B illustrate an exemplary distributed ledger technology (DLT) architecture, in accordance with an embodiment of the invention. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 includes a distributed ledger 204 being maintained on multiple devices (nodes) 202 that are authorized to keep track of the distributed ledger 204. For example, these nodes 202 may be computing devices such as system 130 and client device(s) 140. One node 202 in the DLT architecture 200 may have a complete or partial copy of the entire distributed ledger 204 or set of transactions and/or transaction objects 204A on the distributed ledger 204. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 2B, an exemplary transaction object 204A may include a transaction header 206 and a transaction object data 208. The transaction header 206 may include a cryptographic hash of the previous transaction object 206A, a nonce 206B—a randomly generated 32-bit whole number when the transaction object is created, cryptographic hash of the current transaction object 206C wedded to the nonce 206B, and a time stamp 206D. The transaction object data 208 may include transaction information 208A being recorded. Once the transaction object 204A is generated, the transaction information 208A is considered signed and forever tied to its nonce 206B and hash 206C. Once generated, the transaction object 204A is then deployed on the distributed ledger 204. At this time, a distributed ledger address is generated for the transaction object 204A, i.e., an indication of where it is located on the distributed ledger 204 and captured for recording purposes. Once deployed, the transaction information 208A is considered recorded in the distributed ledger 204.

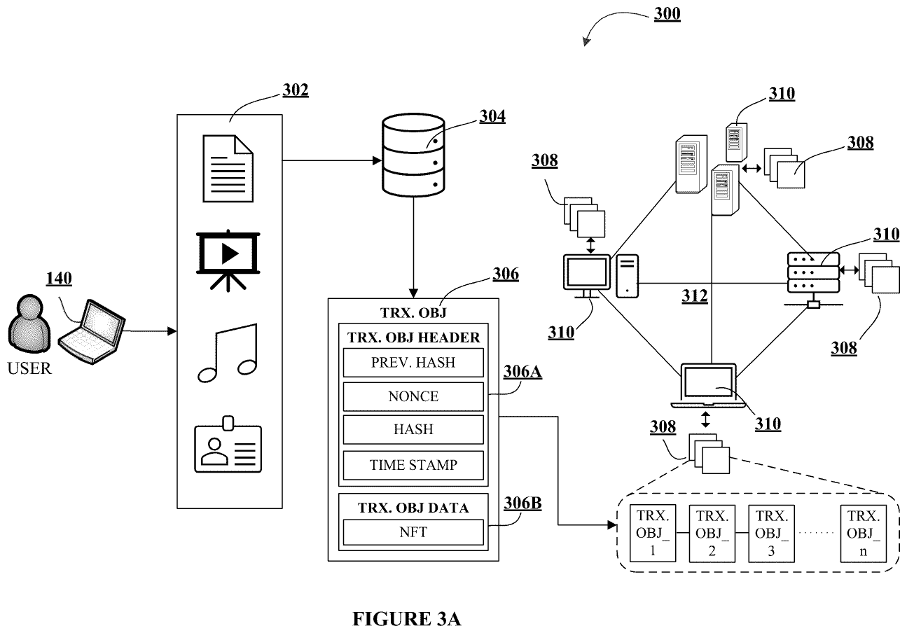

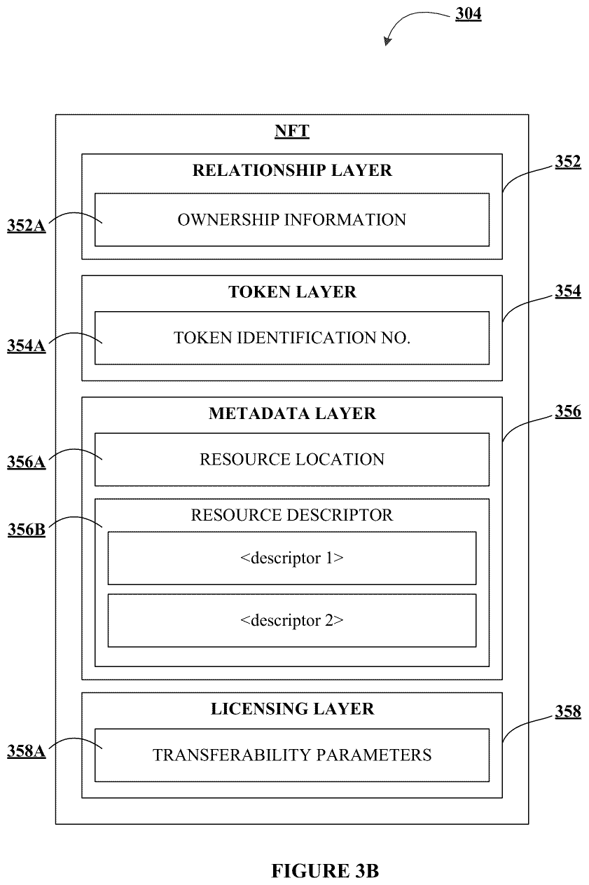

FIG. 3A illustrates an exemplary process of creating an NFT 300, in accordance with an embodiment of the invention. As shown in FIG. 3A, to create or “mint” an NFT, a user (e.g., NFT owner) may identify, using a user input device 140, resources 302 that the user wishes to mint as an NFT. Typically, NFTs are minted from digital objects that represent both tangible and intangible objects. These resources 302 may include a piece of art, music, collectible, virtual world items, videos, real-world items such as artwork and real estate, or any other presumed valuable object. These resources 302 are then digitized into a proper format to produce an NFT 304. The NFT 304 may be a multi-layered documentation that identifies the resources 302 but also evidences various transaction conditions associated therewith, as described in more detail with respect to FIG. 3A.

To record the NFT in a distributed ledger, a transaction object 306 for the NFT 304 is created. The transaction object 306 may include a transaction header 306A and a transaction object data 306B. The transaction header 306A may include a cryptographic hash of the previous transaction object, a nonce-a randomly generated 32-bit whole number when the transaction object is created, cryptographic hash of the current transaction object wedded to the nonce, and a time stamp. The transaction object data 306B may include the NFT 304 being recorded. Once the transaction object 306 is generated, the NFT 204 is considered signed and forever tied to its nonce and hash. The transaction object 306 is then deployed in the distributed ledger 308. At this time, a distributed ledger address is generated for the transaction object 306, i.e., an indication of where it is located on the distributed ledger 308 and captured for recording purposes. Once deployed, the NFT 304 is linked permanently to its hash and the distributed ledger 308, and is considered recorded in the distributed ledger 308, thus concluding the minting process

As shown in FIG. 3A, the distributed ledger 308 may be maintained on multiple devices (nodes) 310 that are authorized to keep track of the distributed ledger 308. For example, these nodes 310 may be computing devices such as system 130 and end-point device(s) 140. One node 310 may have a complete or partial copy of the entire distributed ledger 308 or set of transactions and/or transaction objects on the distributed ledger 308. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 3B illustrates an exemplary NFT 304 as a multi-layered documentation of a resource, in accordance with an embodiment of an invention. As shown in FIG. 3B, the NFT may include at least relationship layer 352, a token layer 354, a metadata layer 356, and a licensing layer 358. The relationship layer 352 may include ownership information 352A, including a map of various users that are associated with the resource and/or the NFT 304, and their relationship to one another. For example, if the NFT 304 is purchased by buyer B1 from a seller S1, the relationship between B1 and S1 as a buyer-seller is recorded in the relationship layer 352. In another example, if the NFT 304 is owned by O1 and the resource itself is stored in a storage facility by storage provider SP1, then the relationship between O1 and SP1 as owner-file storage provider is recorded in the relationship layer 352. The token layer 354 may include a token identification number 354A that is used to identify the NFT 304. The metadata layer 356 may include at least a file location 356A and a file descriptor 356B. The file location 356A may provide information associated with the specific location of the resource 302. Depending on the conditions listed in the smart contract underlying the distributed ledger 308, the resource 302 may be stored on-chain, i.e., directly on the distributed ledger 308 along with the NFT 304, or off-chain, i.e., in an external storage location. The file location 356A identifies where the resource 302 is stored. The file descriptor 356B may include specific information associated with the source itself 302. For example, the file descriptor 356B may include information about the supply, authenticity, lineage, provenance of the resource 302. The licensing layer 358 may include any transferability parameters 358B associated with the NFT 304, such as restrictions and licensing rules associated with purchase, sale, and any other types of transfer of the resource 302 and/or the NFT 304 from one person to another. Those skilled in the art will appreciate that various additional layers and combinations of layers can be configured as needed without departing from the scope and spirit of the invention.

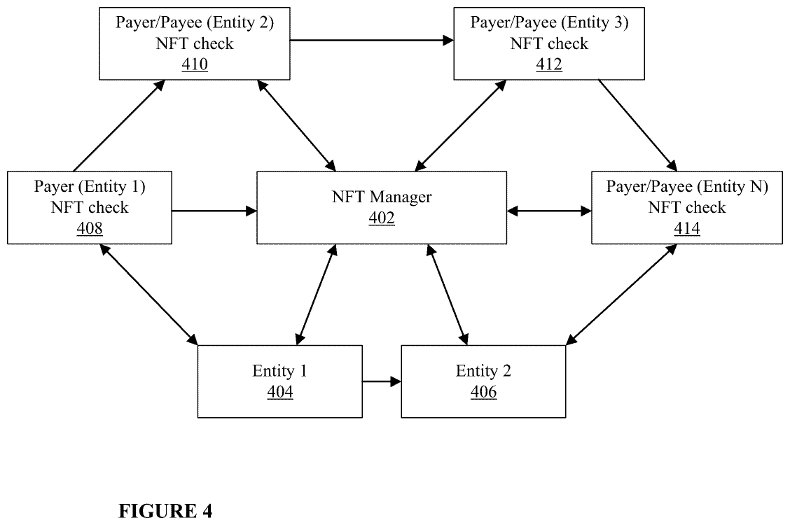

FIG. 4 illustrates an exemplary NFT Manager 402 process flow with various users, systems, or entities, in accordance with an embodiment of an invention. As shown in FIG. 4, the NFT Manager 402 may act as a called service to multiple entities, payers, payees, or the like, such as Entity 1 404, Entity 2 406, Payer from Entity 1 and their NFT check 408, Payer/Payee of Entity 2 and their NFT check 410, Payer/Payee of Entity 3 and their NFT check 412, and so on, as indicated by Payer/Payee of Entity “N” and their NFT check 414. It is understood that the original Payer of Entity 1 408 may be responsible for prompting the generation of the original NFT check, and subsequently the system may endorse or re-endorse this same instrument as Payer/Payee 2, 3 . . . . N each receive or decide to forward the instrument on to another person. For instance, a user who maintains an account with Entity 2 may be a Payee when the NFT check is endorsed to them by Payer of Entity 1, but that Payee may choose to re-endorse the NFT check and become a Payer themselves and pass the NFT check in to a user who maintains an account with Entity 3, and so on.

As previously stated, the invention generally comprises a smart and secure check management system that enables customers to generate checks in the form of non-fungible tokens (NFTs) which are freely and securely transferable and can be used for resource withdrawal or transfer of resource amounts in an account. The solution consists of three components: the metadata engine, the NFT manager 402, and the negotiation and encashment component. The metadata engine extracts the required metadata for NFT generation and verifies the customer's identity using voice recognition and phrase matching. The NFT manager 402 creates the NFT with the provided metadata and generates a new check pass code each time the check is endorsed to a new owner. Finally, the negotiation and encashment component is responsible for the realization of the NFT check amount through cash withdrawal or amount transfer. The solution offers almost zero percent chance of malfeasance, as only one user at a time would be the owner of the NFT check. It is understood that the NFT manager 402 may comprise subcomponents such as the metadata engine and the negotiation and encashment component. It is understood further that the NFT manager 402 refers to a software component or system responsible for creating, transferring, and managing Non-Fungible Tokens (NFTs) associated with checks, utilizing metadata provided by a metadata engine. In some example implementations, the NFT manager generates an NFT for a check when it is created for the first time, incorporating the verification percentage, check details, and check passcode obtained from the metadata engine. When the check is endorsed or transferred to another person, the NFT manager requires the provision of a new check passcode, which becomes part of the metadata for the updated NFT. For purposes of this disclosure, an NFT manager is a critical component that enables the secure and efficient management of check-based NFTs by handling the creation, endorsement, and transfer of NFTs, while ensuring that the necessary metadata, including passcodes, is properly incorporated and updated throughout the lifecycle of the NFT.

The process starts with the payer initiating the transaction by requesting an entity (such as the managing entity of NFT manager 402) to generate an NFT check. The entity generates the NFT check via the processes described with regard to FIGS. 2A-3B, and sends it to an end-point device 140 of the payer or a wallet of the payer which is accessed via the end-point device 140. Once the payer receives the NFT check, they can transfer it to a payee. The payee can then endorse the check to another payee by transmitting a secure request to the NFT manager 402, and the subsequent payee can further endorse it to another payee or deposit it in their account with their respective entity. In some example implementations, a combination of passcodes and voice matching may be used to verify a person's identity through a percentage match verification technique. This process involves collecting a voice sample of the user during registration, which is securely stored and associated with the user's account as a reference for future identity verification. A unique passcode is generated or provided by the user, serving as an additional layer of security. When the user needs to authenticate their identity, the system prompts them to provide their passcode and a new voice sample. The system compares the provided passcode with the stored passcode, and if they match, proceeds to the voice matching step. Voice recognition algorithms analyze the characteristics of the user's voice, such as pitch, tone, and speaking patterns, to determine the similarity between the samples. Based on the comparison results, a percentage match score is calculated, and the system compares this score with a predefined threshold value. If the percentage match score meets or exceeds the threshold value, the user's identity is considered verified, and the system grants access or approves the requested action. This percentage match verification technique using passcodes and voice matching offers a secure and efficient method for authenticating a person's identity, leveraging multiple factors to increase the reliability and security of the authentication process.

In the realm of biometric voice matching, various algorithms are employed to analyze and compare voice samples to determine their similarity. One such example is the Mel Frequency Cepstral Coefficients (MFCC) algorithm, which extracts the most relevant features of a voice sample by mimicking the human auditory system's perception of sound. Another example is the Gaussian Mixture Model (GMM), which represents the extracted features as a combination of Gaussian distributions, effectively modeling the statistical properties of the voice features. Additionally, Dynamic Time Warping (DTW) is an algorithm that can be used to measure the similarity between two temporal sequences by aligning them in a time-normalized manner.

Programmatically and mathematically, the voice matching process typically involves several steps. First, preprocessing is performed on the voice samples to reduce noise, normalize volume, and remove silence. Next, feature extraction is carried out to obtain a compact representation of the voice samples, which is achieved by applying algorithms such as MFCC. After feature extraction, the resulting feature vectors are compared and analyzed using techniques like GMM or DTW to measure the similarity between the voice samples.

In the case of percentage calculations, a similarity score is obtained by comparing the aligned feature vectors using distance metrics, such as Euclidean distance or Mahalanobis distance. This score is then normalized to a scale ranging from 0 to 100, where 0 represents no similarity and 100 represents a perfect match. The normalization process can involve dividing the obtained similarity score by the maximum possible score and multiplying the result by 100 to obtain the percentage match. Biometric voice matching and percentage calculations involve a series of steps, including preprocessing, feature extraction, comparison of feature vectors, and normalization of similarity scores. By employing algorithms such as MFCC, GMM, and DTW, voice matching systems can effectively determine the similarity between voice samples and express this as a percentage match, providing a reliable and quantifiable measure of voice-based identity verification.

When the payee decides to deposit the check, the entity will transfer the NFT to the payer's entity. The payer's entity will then deduct the amount from the payer's account and transfer the amount to the payee's entity. At this point, the payer's entity becomes the owner of the NFT check, as verified through the NFT manager 402. The final payee's entity will transfer the actual amount to the payee's account or allow them to withdraw other types of resources. This entire process ensures that the NFT check is securely and freely transferable and reduces the possibility of malfeasance as the NFT check can only be owned by one person at a time.

It is understood that the NFT check itself may be represented by a unique hash token. Programmatically, the unique hash token may be changed and linked back to a previous unique hash token each time the NFT check is endorsed, transferred, or “cashed.” As previously stated, a “hash token” or “unique hash token” may generally refer to a fixed-length, alphanumeric string generated by applying a cryptographic hash function to a specific input, such as a file, a message, or transaction data. The unique hash token represents a digital fingerprint of the input and has the property that even a small change in the input will produce a significantly different hash output. For purposes of this disclosure, a hash token is typically created using a deterministic algorithm, ensuring that the same input will always generate the same hash output, allowing for efficient and secure data validation, indexing, and comparison in various applications.

Deterministic algorithms may generally refer to a class of algorithms that produce consistent and predictable outputs for a given set of inputs. These algorithms follow a predefined set of rules or steps, ensuring that the same input will always generate the same output. Examples of deterministic algorithms include Merge Sort, which is a comparison-based sorting algorithm that divides an array into halves, sorts each half, and then merges the sorted halves back into a single sorted array; Binary Search, an efficient search algorithm that operates on a sorted array or list by repeatedly dividing the search interval in half; Dijkstra's Shortest Path Algorithm, a graph traversal algorithm used to find the shortest path between nodes in a weighted graph with non-negative edge weights; and the Euclidean Algorithm, a method for finding the greatest common divisor (GCD) of two integers. For purposes of this disclosure, deterministic algorithms play a crucial role in various applications and systems, offering reliability, predictability, and consistency in their execution, enabling the development of efficient and dependable software solutions.

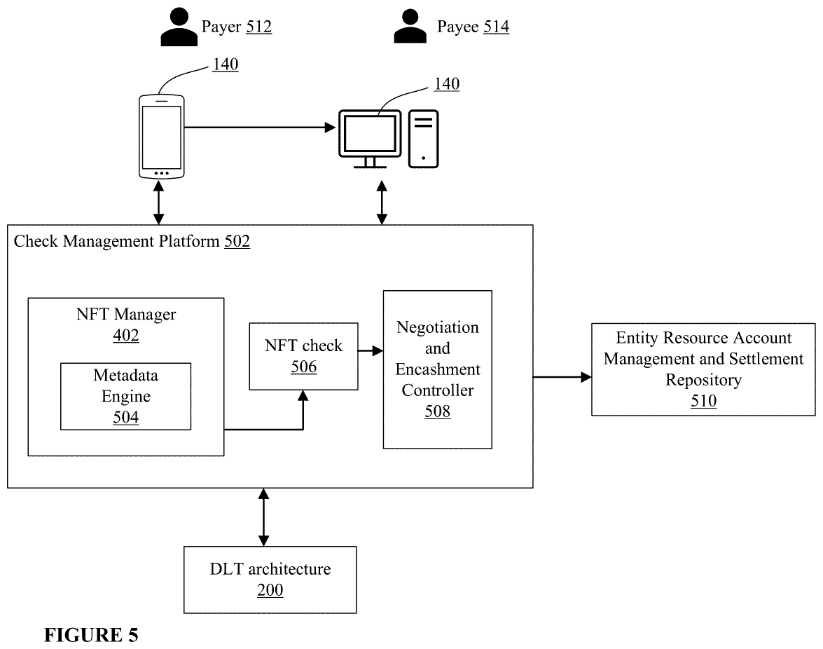

FIG. 5 illustrates an exemplary process flow NFT check request, generation, and processing, in accordance with an embodiment of an invention. As shown in FIG. 5, a payer 512 may initiate a request to the check management platform 502 via an end-point device 140. In some embodiments, the check management platform 502 is a component subsystem of system 130. As indicated in FIG. 5, the check management platform 502 includes the NFT manager 402, metadata engine 504, one or more NFT check(s) 506, and negotiation and encashment controller 508. The check management platform 502 is in operable communication with the DLT architecture 200 of FIGS. 2A-2B in order to generate the one or more NFT check(s) 506 and to update information related to the endorsement, transfer, or the like of the NFT check(s) 506. As further indicated in FIG. 5, the check management platform 502 may transmit information to the entity resource account management and settlement repository 510 such that the entity managing one or more resource account(s) can reconcile resource data for one or more accounts as related to the cashing, endorsement, or generation of the NFT check(s) 506.

In some embodiments, the user, such as payee 512, is able to initiate generation of an NFT check by making a request through a digital banking platform via their end-point device 140. The request can be made via online banking application, mobile banking application, SMS banking application, or any other digital channel available to the user by nature of the NFT manager 402 being made available by the system via an application programming interface. The user can initiate the request by providing the required information for generating an NFT check such as the amount, payee details, and any other relevant metadata to the check management platform 502. Once the request is submitted, the system generates an NFT check and sends it to the user. The NFT check is secured and freely transferable, ensuring that only one person can own the NFT check at a time. This method provides a secure and efficient way for users to initiate an NFT check through their preferred digital banking platform. Making the NFT manager 402 service available via an Application Programming Interface (API) involves creating an interface that allows developers to programmatically access an NFT generation service. The API acts as an intermediary between the NFT generation service and the developers who are using the service to embed the service within their application of the end-point device 140. In some embodiments, the NFT generation service can be hosted on the cloud, and developers can use the API to request an NFT generation by sending HTTP requests to the API endpoint. The API endpoint then invokes the NFT generation service and returns the generated NFT data as a response to the developer's HTTP request.

To make the NFT generation service available via an API, the service provider needs to define the API endpoints, including the HTTP methods supported (such as GET, POST, PUT, DELETE), the parameters required, and the response format. The API endpoints should be designed to accept user input in the form of JSON, XML or other commonly used data formats. It is understood that the service provider should also ensure that the API endpoints are secure and use authentication and authorization mechanisms to control access to the service, such as those described herein with respect to passcode and voice authentication, or the like. Once the API is developed and tested, the service provider, such as the managing entity herein, may publish API documentation that includes the API endpoints, parameters, and examples of API requests and responses. One of ordinary skill in the art will recognize that the API documentation should also include details about authentication and authorization mechanisms and any usage limits or restrictions.

In some embodiments, the API documentation may be utilized to integrate the NFT generation service into one or more applications. Developers can send HTTP requests to the API endpoint, passing the required parameters, and receive the NFT data as a response. Developers can use this functionality to create customized NFTs or integrate NFT generation into their applications, enabling their users to generate NFTs through the API.

In order for the NFT manager 402 to generate an NFT check, the user must provide requisite authentication credentials to access the service, and then must also provide other details for which the unique hash token of the NFT will be based. For instance, in terms of authentication, the user may provide a passcode or voice print sample in order for the system of the invention to determine if the passcode matches the user's account, and determine a percentage confidence score that the user's voice print sample matches their voice print on file. If the user is authenticated, the invention provides a system for generating checks via digital banking channels such as online banking and mobile banking. To generate a check, the user can go to the check generation screen on the digital banking platform of their end-point device 140 and input the relevant information such as payee details, amount, and any other relevant metadata that the entity may require (e.g., resource account identifier, check memo, or the like). Once the user submits the request, the system generates the check internally and forwards it to the NFT manager 402 for generation of a unique hash token based on the requested resource action.

Alternatively, in some embodiments, it is contemplated that users can generate checks via SMS banking. In this case, the user sends a request to the bank via SMS, and the bank sends a message back with the format in which the check generation details are to be sent. The user then follows the format and sends the required information, and the bank generates the check and sends it to the user. The system ensures that the generated checks are secured and freely transferable, reducing the possibility of malfeasance. This provides a secure and efficient way for users to generate checks through their preferred digital banking channel. In addition to the details of the resource action, or resource action details, the user may also provide a unique check passcode. The resource action details may include the payee's name, the amount to be transferred, the transfer type (cash or account) in addition to the check pass code. The check pass code is a unique code that the payee will use during encashment of the NFT check 506, and which the check management platform 502 may store separately as authentication that the payee 514 is authorized to cash the NFT check 506.

Once the bank receives the details, the system may contact the entity resource account management and settlement repository 510 in order to verify that the user's account has the necessary resources to complete the resource action. The system may then generate the check via the DLT architecture 200 and sends it to the payer 512 or a digital wallet associated with the payer 512. In accordance with the present disclosure, the process of generating an NFT from a programming perspective can be described in a series of steps. The process commences with the collection of required metadata (such as payee details, amount, and any other relevant metadata that the entity may require, or the like) which forms the basis of the NFT's unique characteristics. Metadata may include, but is not limited to, ownership information, instrument details, provenance, or any other relevant attributes, or the like.

Upon gathering the necessary metadata, a unique identifier, such as a hash value, is computed using a cryptographic hashing algorithm. This identifier serves as a distinct digital fingerprint for the NFT, ensuring its uniqueness and immutability. The hash value is generated by processing the metadata through the selected hashing algorithm, resulting in a fixed-length output that represents the input data. Subsequently, a smart contract is created to govern the rules and interactions associated with the NFT. The smart contract is typically written in a programming language compatible with the blockchain platform on which the NFT will be hosted, such as Solidity for the Ethereum network. The smart contract may define the NFT's properties, ownership transfer mechanisms, royalty structures, and other functionalities relevant to the specific use case.

Once the smart contract is developed and tested for functionality and security, it is deployed to the selected blockchain network. The deployment process involves the submission of the smart contract code to the network, along with any necessary transaction costs or gas costs. Upon successful deployment, the smart contract is assigned a unique address on the blockchain, which serves as a reference point for future interactions with the NFT.

With the smart contract in place, the NFT can be minted by invoking a specific function within the contract. This function typically takes the unique identifier and metadata as input parameters and creates a new NFT on the blockchain, associating the metadata with the NFT and assigning initial ownership. The newly minted NFT is then stored on the blockchain as an immutable record, enabling secure and transparent tracking of its ownership, history, and associated attributes. The generated NFT check(s) 506 are secured and freely transferable, reducing the possibility of malfeasance. This provides a secure and efficient way for customers to generate checks through their preferred digital channel.

In accordance with the present disclosure, the financial institution, herein referred to as “the entity,” generates a unique Non-Fungible Token (NFT) link associated with a specific transaction or instrument. Once generated, the entity shares this NFT link with the intended recipient (such as the payee, or the like) or with the payer, such that they can share it with the payee, through various communication channels, depending on the recipient's current connectivity status. If the recipient does not have access to the internet, the entity transmits the NFT link via Short Message Service (SMS) to the recipient's registered mobile number. This method ensures that the recipient can receive the NFT link even in the absence of an active internet connection. Alternatively, if the recipient has internet connectivity, the entity may choose to send the NFT link through mobile banking applications, email, or the like. This approach leverages the advantages of internet-based communication channels for efficient and timely delivery of the NFT link. By employing multiple communication channels based on the recipient's connectivity status, the entity ensures that the NFT link is effectively delivered, facilitating seamless interactions and transactions involving the associated NFT. This method optimizes the user experience and accessibility of NFT-based services provided by the entity, catering to varying connectivity scenarios and user preferences.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for orchestrating resource instruments in an electronic network utilizing unique hash tokens, the system comprising:
a processing device;
a non-transitory storage device containing instructions when executed by the processing device, causes the processing device to perform the steps of:
receive resource action data from an end-point device of a user;
determine metadata from the resource action data required for generating a non-fungible token (NFT) representing an NFT check;
perform a biometric voice verification of the user via data received from the end-point device of the user to authenticate the user's identity;
utilize a distributed ledger architecture to generate the NFT based on the metadata;
transmit unique hash code data representing the NFT to an entity resource account management and settlement repository;
generate a link to the NFT; and
transmit the link to the NFT to the end-point device of the user.

2. The system of claim 1, wherein the metadata further comprises a resource account identifier, a resource amount, a payee identifier, a payer identifier, or a check memo.

3. The system of claim 1, wherein the metadata further comprises an NFT check passcode, wherein the NFT check passcode is required to access the NFT via an NFT management platform.

4. The system of claim 1, wherein biometric voice verification further comprises the steps of:
receive a voice sample of the user's voice via the end-point device of the user;
preprocess the voice sample to reduce noise, normalize volume, and remove silence from the voice sample;
perform a feature extraction on the voice sample to generate a compact representation of the voice sample by applying a Mel Frequency Cepstral Coefficients (MFCC) algorithm;
compare and analyze resulting feature vectors to determine a similarity score via one or more aligned feature vectors; and
normalize the score to a scale ranging from 0-100, wherein 0 represents no similarity, and 100 represents a perfect match.

5. The system of claim 1, wherein transmitting the link to the NFT to the end-point device of the user further comprises sending the link via a mobile application of the end-point device.

6. The system of claim 1, wherein transmitting the link to the NFT to the end-point device of the user further comprises sending a Short Message Service (SMS) to a registered mobile number of the user.

7. The system of claim 1, further comprising the steps of:
receive the NFT from a second user;
verify the second user as an authorized payee based on the extracted metadata; and
automatically withdraw resources from a resource account of the user and transmitting the resources to a resource account of the second user.

8. A computer program product for orchestrating resource instruments in an electronic network utilizing unique hash tokens, the computer program product comprising a non-transitory computer-readable medium comprising code causing an apparatus to:
receive resource action data from an end-point device of a user;
determine metadata from the resource action data required for generating a non-fungible token (NFT) representing an NFT check;
perform a biometric voice verification of the user via data received from the end-point device of the user to authenticate the user's identity;
utilize a distributed ledger architecture to generate the NFT based on the metadata;
transmit unique hash code data representing the NFT to an entity resource account management and settlement repository;
generate a link to the NFT; and
transmit the link to the NFT to the end-point device of the user.

9. The computer program product of claim 8, wherein the metadata further comprises a resource account identifier, a resource amount, a payee identifier, a payer identifier, or a check memo.

10. The computer program product of claim 8, wherein the metadata further comprises an NFT check passcode, wherein the NFT check passcode is required to access the NFT via an NFT management platform.

11. The computer program product of claim 8, wherein biometric voice verification further comprises the steps of:
receive a voice sample via the end-point device of the user;
preprocess the voice sample to reduce noise, normalize volume, and remove silence from the voice sample;
perform a feature extraction on the voice sample to generate a compact representation of the voice sample by applying a Mel Frequency Cepstral Coefficients (MFCC) algorithm;
compare and analyze resulting feature vectors to determine a similarity score via one or more aligned feature vectors of the voice sample in comparison to a previously stored voice sample of the user; and
normalize the similarity score to a scale ranging from 0-100, wherein 0 represents no similarity, and 100 represents a perfect match.

12. The computer program product of claim 8, wherein transmitting the link to the NFT to the end-point device of the user further comprises sending the link via a mobile application of the end-point device.

13. The computer program product of claim 8, wherein transmitting the link to the NFT to the end-point device of the user further comprises sending a Short Message Service (SMS) to a registered mobile number of the user.

14. The computer program product of claim 8, the computer program product further comprising a non-transitory computer-readable medium comprising code causing an apparatus to:
receive the NFT from a second user;
verify the second user as an authorized payee based on the extracted metadata; and
automatically withdraw resources from a resource account of the user and transmitting the resources to a resource account of the second user.

15. A method for orchestrating resource instruments in an electronic network utilizing unique hash tokens, the method comprising:
receiving resource action data from an end-point device of a user;
determining metadata from the resource action data required for generating a non-fungible token (NFT) representing an NFT check;
performing a biometric voice verification of the user via data received from the end-point device of the user to authenticate the user's identity;
utilizing a distributed ledger architecture to generate the NFT based on the metadata;
transmitting unique hash code data representing the NFT to an entity resource account management and settlement repository;
generating a link to the NFT; and
transmitting the link to the NFT to the end-point device of the user.

16. The method of claim 15, wherein the metadata further comprises a resource account identifier, a resource amount, a payee identifier, a payer identifier, or a check memo.

17. The method of claim 15, wherein the metadata further comprises an NFT check passcode, wherein the NFT check passcode is required to access the NFT via an NFT management platform.

18. The method of claim 15, wherein biometric voice verification further comprises the steps of:
receiving a voice sample via the end-point device of the user;
preprocessing the voice sample to reduce noise, normalize volume, and remove silence from the voice sample;
performing a feature extraction on the voice sample to generate a compact representation of the voice sample by applying a Mel Frequency Cepstral Coefficients (MFCC) algorithm;
comparing and analyze resulting feature vectors to determine a similarity score via one or more aligned feature vectors of the voice sample in comparison to a previously stored voice sample of the user; and
normalizing the similarity score to a scale ranging from 0-100, wherein 0 represents no similarity, and 100 represents a perfect match.

19. The method of claim 15, wherein transmitting the link to the NFT to the end-point device of the user further comprises sending the link via a mobile application of the end-point device.

20. The method of claim 15, wherein transmitting the link to the NFT to the end-point device of the user further comprises sending a Short Message Service (SMS) to a registered mobile number of the user.
